(19) United States
(12) Patent Application Publication
(10) Pub. No.: US 2015/0313177 A1
(43) Pub. Date: Nov. 5, 2015

(54) CONTROLLED DISTRIBUTION GRAIN CONTAINER

(71) Applicants: Donald L. Smith, Pasadena, TX (US); Angela M. Smith, Pasadena, TX (US)

(72) Inventors: Donald L. Smith, Pasadena, TX (US); Angela M. Smith, Pasadena, TX (US)

(21) Appl. No.: 14/700,474

(22) Filed: Apr. 30, 2015

Related U.S. Application Data
(60) Provisional application No. 61/987,560, filed on May 2, 2014.

(51) Int. Cl. A01K 5/02; B65D 33/14; A01M 31/00; B65D 33/24; B65D 33/25; A45F 3/00; B65D 30/00; B65D 33/28

(52) U.S. Cl. CPC A01K 5/0225; B65D 29/00; B65D 33/14; B65D 33/28; B65D 33/24; B65D 33/2591; A45F 3/00; A01M 31/00; A45F 2003/003

(57) ABSTRACT

The invention is a controlled distribution grain container for transporting feed or grain into a hunting area for feeding or planting. The first end and the second end of the “poncho”, which in use will form the lower edges of the front and back of the poncho, each have an open spout, each with a closure means. The first end and second end of the controlled distribution grain container will be located at the front and the back of the user, respectively, when the device is worn over the user's shoulders. The poncho style controlled distribution grain container has one or more openings, each with a closure means such as zippers, to fill or refill the device. These openings are located on the front or back panels or along the edges of the sides of the device. The device allows the user to carry grain with the weight evenly distributed front to back and over his shoulders. After transporting the feed or grain to the desired area the user simply loosens the desired draw string allowing the feed or grain to freely flow out or they can use their hand; to control the flow of the feed or grain. When the contents of one end is gone the controlled distribution grain container is simply swiveled around the user's neck and the process is repeated.

### CROSS-REFERENCE TO RELATED APPLICATIONS

This application claims priority to U.S. Provisional Patent Application No. 61/987,560, filed on May 2, 2014. The entirety of the aforementioned application is incorporated herein by reference.

### FIELD OF THE INVENTION

The present invention relates to an apparatus for transporting and distributing grain or feed. More specifically, it is related to such an apparatus suited for transport and distribution of feed in areas not easily accessible by equipment. Grain distribution containers are not new to the art. However, a poncho style grain distribution container that has an opening in the front and an opening in the back for distribution of the grain is. Applicants have invented a new and useful device, a CONTROLLED DISTRIBUTION GRAIN CONTAINER that is further described below.

### BACKGROUND OF THE INVENTION

In U.S. Pat. No. 7,004,111 entitled, “Treat dispenser”, issue to Olson on Feb. 28, 2006 teaches an animal reward dispensing apparatus that attaches to a trainer's arm. The device is attached by straps and has a spring loaded finger release for dispensing the treats at the appropriate time. This device has two ends that open, but it does not dispense from both openings as the present invention does. The present invention also is configured to dispense feed, grains or beans as one walks about spreading the feed, grain or beans over a large area for baiting or for planting. The present invention has a great utility in that it can be operated to distribute the contents from the front portion of the container then swiveled or rotated around the user's neck and the contents from the other portion can be distributed as walking about.

The present invention is a transport and distribution container for distributing feed or grain around a hunting area. Both sides can be filled through the zipper on the front. When hunters arrive at the hunting area they simply loosen the draw string and the feed or grain falls from the opening. When the one side is empty the user spins the bag around their neck and repeats the process emptying both sides. The bag allows the hunter to take the feed or grain to their hunting area hands free. Hunters can carry their hunting equipment and bait with ease with the weight evenly distributed. The bag can also be used to transport and spread seed, feed or grain in areas that will not accommodate equipment for that purpose.

### SUMMARY OF THE INVENTION

The present invention is a “poncho” shaped controlled distribution grain container. The container comprises an enclosed bag. The bag has a first end and a second end and a front and a back panel. There is a centrally located, aligned, opening through the two panels of the bag. The first end and the second end each have an open spout. The spout has a closure means. The grain container has at least one closeable opening for filling the enclosed bag.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 shows in plan view the controlled distribution grain container from the front panel;

FIG. 2 shows the controlled distribution grain container from the side;

FIG. 3 shows the controlled distribution grain container being worn from the front of the wearer; and

FIG. 4 shows the controlled distribution grain container being worn from the side.

### DETAILED DESCRIPTION OF THE INVENTION

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting.

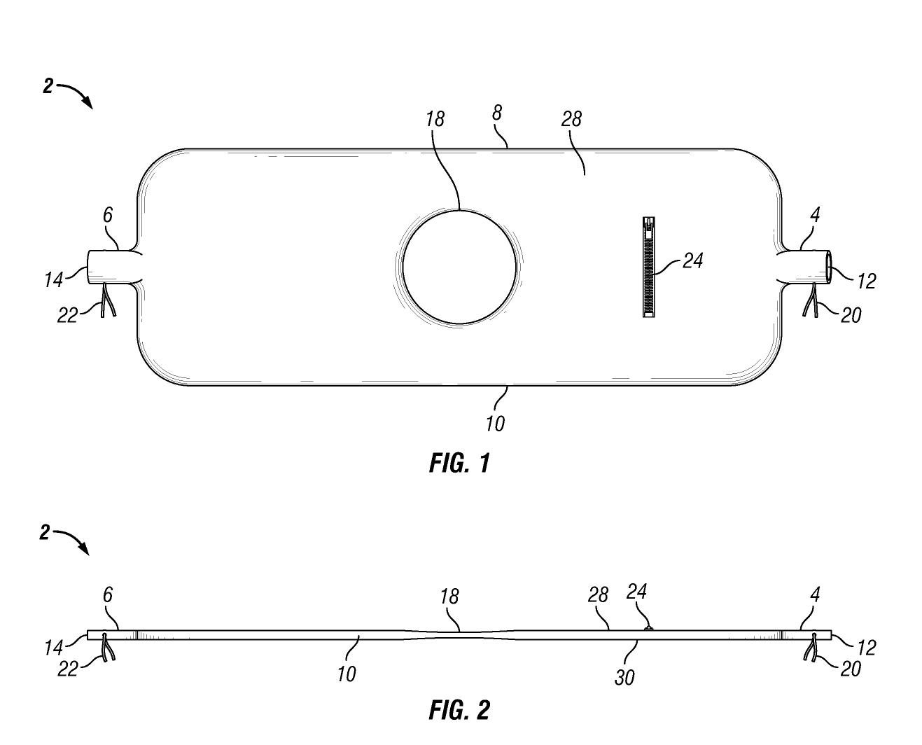

FIG. 1 shows the controlled distribution grain container 2 from the front panel 28. The controlled distribution grain container 2 is an enclosed bag that has a first end 4 and a second end 6. The controlled distribution grain container 2 has a first side or edge 8 and a second side or edge 10. The first end 4 of the controlled distribution grain container 2 has a first end opening 12. The second end 6 of the controlled distribution grain container 2 has a second end opening 14. The openings 12 and 14 are provided with means for closing. A simple light weight, and useful closing is formed with a drawstring, as illustrated, but other means of closing such as button flaps, zippers, Velcro or snaps can be used. This embodiment of the controlled distribution grain container 2 has a front opening 23 with a zipper 24. Alternatively opening 23 can be closed by other means such as button flaps, Velcro, or snaps.

FIG. 2 shows the controlled distribution grain container 2 from the second side 10. The first end 4 has the first opening 12 and the first draw string 20. The second end 6 of the controlled distribution grain container 2 has a second end opening 14 and a second draw string 22. The neck opening 18 starts from the front panel 28 and continues through the back panel 30.

Referring to both FIGS. 1 and 2, the controlled distribution container, or bag, is formed so the front and back panels 28 and 30 are contiguous, or are sealed or fastened, by means known in the art such as sewing, stitching or glue, around the perimeter of the sides and around the perimeter of the neck opening 18 to prevent loss of any of the contents within, except through the openings 12 and 14 when the means for closing is opened. Each panel 28 and 30 can be made of any firm and durable fabric, such as, by way of example and not by limitation, twilled cotton or cotton/polyester blend fabric, denim, gabardine, drill or duck. The fabric for each side can be any color or pattern.

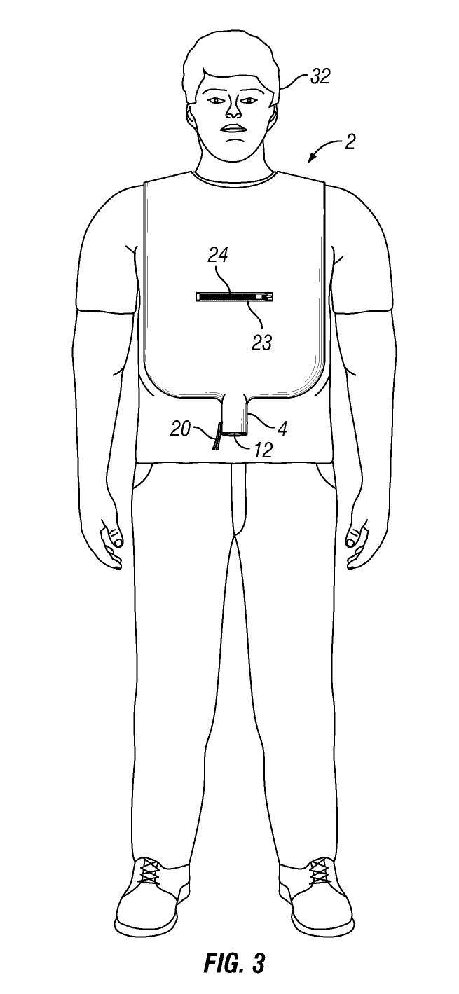

FIG. 3 shows the controlled distribution grain container 2 being worn from the front. Here it is clear that the controlled distribution grain container 2 slips over the users head 32 and is worn like a vest or poncho. This embodiment has the front opening 23 for filling the controlled distribution grain container 2 with feed, grain or beans. This front opening 23 has a zipper 24 for ease of loading the controlled distribution grain container 2. Alternatively the controlled distribution container could have multiple openings 23, situated in both front and back panels 28, 30, or in the sides 8, 10. The front end 4 has first opening 12 that directs the flow of the feed or grain from the controlled distribution grain container 2. The first draw string 20 holds the feed or grain within the controlled distribution grain container 2 until it is loosened to allow the flow of the feed or grain out of the device 2. The user can also use their hand to control the flow after the first draw string 20 has been loosened.

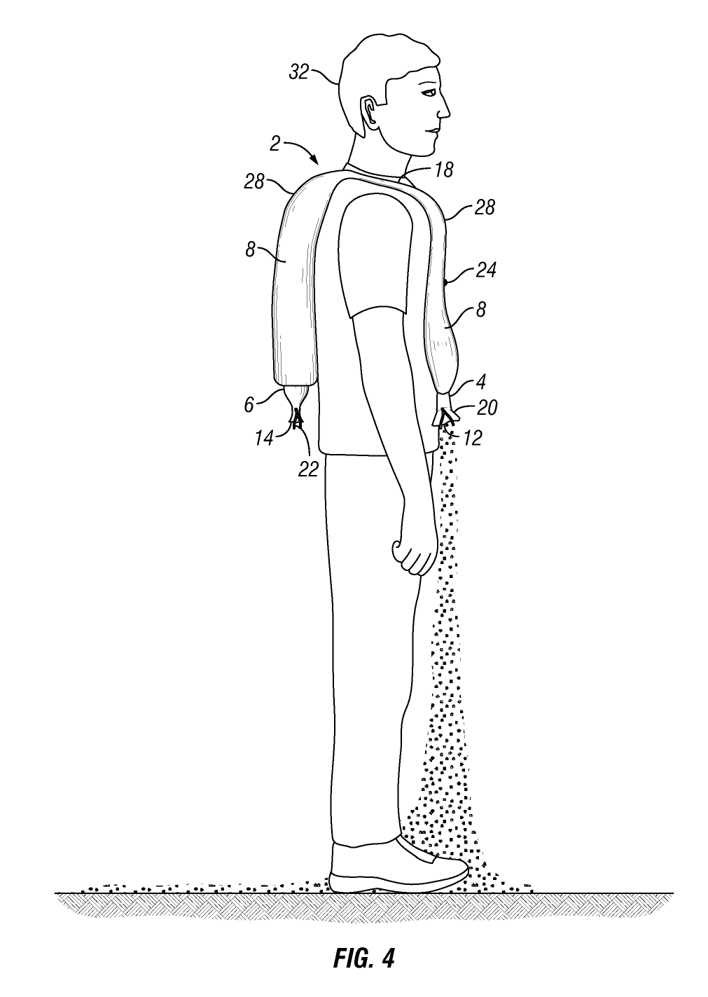

FIG. 4 shows the controlled distribution grain container 2 being worn from the side. Here it is clear that the first end 4 and the second end 6 are similar. The controlled distribution grain container 2 is slipped over the head 32 of the user through the neck opening 18. The controlled distribution grain container 2 rests on the shoulders of the user. The first end 4 of the front 28 has a first end opening 12 that is controlled by a first draw string 20. The second end 6 of the back 30 has a second end opening 14 that is controlled by the second draw string 22. Also clear is the first side 8. When the user has emptied the contents of the first end 4 they simply swivel or rotate the controlled distribution grain container 2 to access the second end 6 for controlled distribution of its contents.

When done the bag will fold into a small, compact item that can easily be stored in a backpack or a pocket for removal from the field.

Embodiments described herein are included to demonstrate particular aspects of the present disclosure. It should be appreciated by those of skill in the art that the embodiments described herein merely represent exemplary embodiments of the disclosure. Those of ordinary skill in the art should, in light of the present disclosure, appreciate that many changes can be made in the specific embodiments described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure.

What is claimed is:

1. A controlled distribution grain container, said container comprising: an enclosed bag, said bag having a first end and a second end, and two panels, a centrally located, aligned, opening through said two panels; said first end and said second end each having an open spout, said spout having a closure means.

2. A controlled distribution grain container as claimed in claim 1 wherein at least one of said panels has at least one closeable opening for filling said enclosed bag.

3. A controlled distribution grain container as claimed in claim 1 wherein said closure means is a tie string.

4. A controlled distribution grain container as claimed in claim 1 wherein said closure means is Velcro.

5. A controlled distribution grain container as claimed in claim 1 wherein said closure means is a zipper.

6. A controlled distribution grain container as claimed in claim 2 wherein said closure means is a tie string.

7. A controlled distribution grain container as claimed in claim 2 wherein said closure means is Velcro.

8. A controlled distribution grain container as claimed in claim 2 wherein said closure means is a zipper.

9. A controlled distribution grain container as claimed in claim 6 wherein said opening for filling is closeable by Velcro.

10. A controlled distribution grain container as claimed in claim 6 wherein said at least one opening for filling is closeable by a zipper.

11. A “poncho” shaped controlled distribution grain container comprising an enclosed bag, said bag comprising a first end and a second end and a front and a back panel, said panels having a centrally located, aligned, opening through said two panels of the bag, wherein first end and said second end each have a spout provided with releasable closure means.

12. The grain container of claim 11 further comprising at least one closeable opening for filling the enclosed bag.

13. A controlled distribution grain container as claimed in claim 2 wherein said bag will hold at least 5 pounds of grain.

14. A controlled distribution grain container as claimed in claim 12 wherein said bag will hold at least 5 pounds of grain.

15. A method of distributing grain, said method comprising;
providing a controlled distribution grain container as claimed in claim 2; introducing grain into said grain container; carrying said grain container while opening at least one said spout to allow a controlled amount of grain to exit the grain container.

16. The method as claimed in claim 15 wherein the grain is corn.

17. The method as claimed in claim 15 wherein the grain is beans.

18. The method as claimed in claim 15 wherein the grain is seed.

19. The method as claimed in claim 15 wherein the grain is feed.
